(19) United States
(12) Patent Application Publication
(10) Pub. No.: US 2002/0130256 A1
(43) Pub. Date: Sep. 19, 2002

(54) Spectrum, time and protocol domain optical performance monitor

(76) Inventors: David Macki, Ottawa (CA); Dave Rodgers, Ottawa (CA); Lawrence Tarof, Kanata (CA); Scott Bradshaw, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/096,284

(22) Filed: Mar. 13, 2002

Related U.S. Application Data
(60) Provisional application No. 60/276,835, filed on Mar. 16, 2001.

(51) Int. Cl. G01J 1/34

(52) U.S. Cl. 250/227.21

(57) ABSTRACT

A spectrum, time and protocol optical power monitor is disclosed. This device utilizes a same photodetector to perform spectral optical monitoring of an incoming optical signal, as well as performing timing and protocol monitoring for preselected wavelength channels. Advantageously the device uses a same passband tunable optical filter for both the spectrum and timing/protocol measurements. The spectral response of the filter passband is deconvolved from the spectral scan in order to achieve improved spectral scan resolution, and the timing and protocol measurements are not degraded by the passband of the filter.

This application claims priority from Provisional Application No. 60/276,835 filed Mar. 16, 2001.

### FIELD OF THE INVENTION

This invention relates to monitoring of optical signal quality within fiber optical transmission systems and more specifically to a device for monitoring of spectral quality and data quality of the optical signal.

### BACKGROUND OF THE INVENTION

In order for a network service provider to provide reliable data to their customers, a need exists for the network service provider to monitor the incoming network data in order to guarantee a level of data quality. For fiber optic networks to operate properly between various network service providers strict requirements for signal performance and integrity are provided. Adherence to an ITU (International Telecommunication Union) standard is critical in order for optical networks of various network service providers to efficiently exchange optical data in today's communication networks. Typically performance and integrity is guaranteed through a process of using components within the network that are designed to meet other standards or sub-standards to the ITU standard, however as the marketplace demands more cost effective component solutions, many manufacturers of optical network products reduce their product performance in order to be more cost competitive in the market. Reducing product performance margins may result in components failing to accurately transmit data. As a result, network service providers need to monitor the quality of signals within their networks in order to ensure compliance to ITU standards and in order to assure customers of data transmission signal quality.

An optical performance monitor (OPM) is a device that is used in a dense wavelength division multiplexed (DWDM) network to monitor the quality of signals within the fiber optic network. In fiber optic networks, data is provided to network service provider in the form of optical signals modulated at individual wavelength channels transmitted along a fiber optic cable. With current WDM technology a plurality of different single wavelength modulated optical data signals propagate within a same fiber. Ideally each of these single wavelength modulated optical data signals is individually monitored in these WDM systems to ensure a certain signal quality.

In a simple DWDM network digital data is optically transmitted via different wavelengths. 1's and 0's are optically transmitted by either modulating a laser, or by using an external monitor. Using the laser modulation technique, a laser at a specific average wavelength is turned on and off. If an external modulator is used, such as a Mach-Zender (MZ) interferometer, then the laser at a predetermined wavelength is turned on and the data is encoded on the optical signal by the modulator. The laser source at a wavelength and associated modulator and other optoelectronics are known as the transmitter (Tx). A number of transmitters are required in order to compose a DWDM signal along a single fiber. Therefore, the resulting optical data signals from each of the Tx sources at various wavelengths, are coupled onto a single fiber using an optical couplers.

At the receiving end after transmission through a single fiber an optical filter rejects all wavelength channels except the single wavelength channel of the modulated optical data signal. A photodetector for receiving this single wavelength optical data converts the optical energy into a photocurrent, which is passed to a receiver (Rx). The Rx converts received optical data into an electronic domain, and provides subsequent functionality such that operations on the received data signal can be performed; for instance an operation like retiming.

Preferably optical communication systems are dynamic in nature, and the more flexibility an optical system has in internal reconfiguration, the more efficiently optical data can be managed therein even in response to change. More flexible optical communication systems are achievable when parameters of the system are dynamic. Unfortunately, most systems deployed in the field today are quite static in nature—having predefined channels, at a number of predefined wavelengths, where essentially a same wavelength is propagated through an optical network from Tx to Rx without any optical wavelength conversion. Much like the way a radio spectrum is preset for the various radio stations.

In order to offer more dynamic performance, the complexity of the network increases, and therefore the ability to monitor various properties of the optical data signals propagating therethrough becomes a requirement; network service providers want to provide unproblematic optical data to their customers.

Problems which may occur within an optical networks are: fiber cuts, wavelength drift at the receiver, wavelength drift between neighbouring WDM channels, and a reduction in received optical power due to poor connectors or low bend radius fibers within the network. Transmitter high-speed electronics or dispersion also degrade optical data signals, resulting in significant bit errors at the receiver. Fortunately, these aforementioned problems are measurable using the OPM. There are two types of OPM measurements; static and dynamic.

Static measurements generally deal with low frequency optical signals and are spectral measurements of optical characteristics of the optical data signal, using average photo current; whereas dynamic involve analyzing characteristics of the optical data signal itself.

Typical measured optical characteristics are: average optical power, OSNR, wavelength, optical spectrum, bit error rate (BER) or eye diagram, and protocol monitoring. The average optical power is the average optical power for each channel within the WDM optical data signal. The average received optical power is a useful check for fiber cut or transmitter power reduction.

The optical spectrum measurement is a measure of the WDM optical data signal propagating through a fiber; it displays optical power as a function of wavelength for a spectrum of interest. Such verification is performed to ensure International Telecommunications Union (ITU) compliance. The optical spectrum also provides valuable information about the amount of background optical noise. The ratio between a peak wavelength power (mW) and a nearest “valley”, or upwards cusp in the optical spectrum, is known as the optical signal to noise ratio (OSNR). OSNR is used as a simple measure of predicting whether significant bit errors will occur. The optical spectrum measurement is also useful for determining whether there is a fiber cut or transmitter power reduction.

The bit error rate (BER) is a direct measure of the quality of a single wavelength channel of a modulated optical data signal received at the Rx. Typically the BER is represented by an “eye diagram”. Eye diagrams are a popular method of visually and mathematically representing the quality of a received optical data signal in fiber optic telecommunications, Optical communication Systems, Gower, Prentice Hall (1993). Experimentally the eye diagram is created from the receipt of a single modulated optical data signal at a predetermined wavelength. If an eye is “open” the quality of the received optical signal is considered to be better. The eye is more “open” if the distance between the top received ‘1’ bit optical power level and the bottom, received “0” optical power level is large, also known as the amplitude margin. Amplitude margin refers to the height of the eye. Phase margin is represented by the distance in time on the eye diagram between the rising and falling edges of the data stream of 1's and 0's. A small phase margin is the result of a greater amount of time taken up in transitioning from a 0 to a 1 and back resulting in the narrower eye shape. Both parameters, phase margin and amplitude margin do not require a diagram resembling an eye to be created, the eye diagram picture is a visual representation of phase and amplitude margin parameters of the received optical data signal, which are extracted mathematically.

Monitoring of phase margin and amplitude margin allows for checking of transmitter power reduction, fiber attenuation, high-speed transmitter electronics and dispersion within the optical network. Protocol Monitoring is used for measuring of specific protocols used within the optical network. Optical protocols have various built in check algorithms; as well they are protocol specific, such as B1 and B2 bytes utilized in a SONET protocol.

It is therefore an object of this invention to provide an OPM which has the ability to measure low frequency spectral information about a WDM optical data signal, as well as high frequency timing and protocol (T/P) monitoring for providing timing and protocol monitoring of a single wavelength optical data signal.

### SUMMARY OF THE INVENTION

In accordance with the invention there is provided an optical performance monitor having an output port for monitoring a modulated optical data signal incident thereon comprising:

a photodetector having an optical input port, and a first output port and a second output port, the photodetector for providing a first non-optical data signal, based on light incident on the optical input port, at the first output port and for providing a second non-optical data signal based on light incident thereon at the second output port;

a tunable filter having a predetermined passband spectrum for receiving the modulated optical data signal and for providing a filtered portion of the modulated optical data signal to the photodetector;

a low frequency electronic circuit coupled to the first port of the photodetector for receiving the first non-optical data signal and for extracting first spectral information from the first non-optical data signal;

a high frequency electronic circuit coupled to the second port of the photodetector for receiving the second non-optical data signal and for extracting timing and protocol information from the second non-optical data signal; and,

a processor for receiving the first spectral information and for deconvolving the predetermined passband spectrum and the first spectral information, to provide data relating to the optical data signal at the optical performance monitor output port; and the processor for providing data relating to extracted timing and protocol information.

In accordance with an additional aspect of the invention there is provided a method of monitoring a modulated optical data signal comprising the steps of:

filtering an incoming modulated optical data signal using a tunable filter having a predetermined passband spectrum;

provide the filtered modulated optical data signal to a photodetector;

converting light incident on the photodetector to a first non-optical signal using a low frequency circuit;

extracting first spectral information from the first non-optical data signal; and,

deconvolving the predetermined passband spectrum and the first spectral information to provide data relating to the optical data signal.

In accordance with an additional aspect of the invention there is provided a method of locking a filter position based on a peak location within a spectrum of an optical signal comprising the steps of:

providing an optical signal including a first optical signal and a reference optical signal having a known spectrum;

filtering the provided optical signal using a first filter detecting at least a portion of the filtered optical signal using a detector; and,

tuning the first filter in dependence upon a detected portion of the at least a portion of the filtered optical signal relating to a portion of the provided optical signal including the reference optical signal.

### BRIEF DESCRIPTION OF THE DRAWINGS

The invention will now be described with reference to the drawings in which:

FIG. 1 is an illustration of a prior art spectrum domain optical performance monitor using a tunable filter;

FIG. 2 is an illustration of an output spectrum obtained from the prior art device;

FIG. 3 is a block diagram of the preferred embodiment, which is a spectrum, time and protocol OPM;

FIG. 4a is a diagram of an unmodulated spectral scan of single channel optical data signal;

FIG. 4b is a diagram of the spectral width of the single channel as it is broadened about its central wavelength;

FIG. 5 is an eye diagram depicting for a modulated signal, having clean and sharp rising and falling edges;

FIG. 6a illustrates the spectral shape of the optical passband of a tunable filter as well as a modulated single optical channel spectral shape;

FIG. 6b illustrates the transmitted portion of the single channel optical data signal after filtering;

FIG. 7 illustrates an eye diagram of a degraded optical data signal;

FIG. 8 illustrates the spectral shape of the tunable filter having a 20 GHz passband;

FIG. 9 illustrates the optical spectrum after transmitting through the 20 GHz filter passband; and,

FIG. 10 is an outline of the decision steps used for determining whether to perform a spectral scan or a T/P scan.

### DETAILED DESCRIPTION OF THE INVENTION

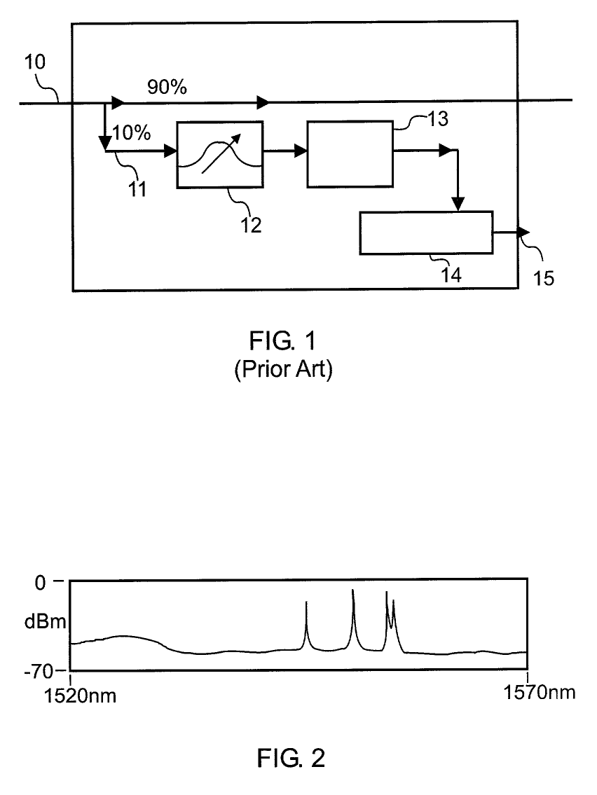

There are many Optical Performance Monitors (OPMs) in the marketplace that perform optical spectrum measurements, a block diagram of a prior art OPM is shown in FIG. 1. OPMs generally utilize a low percentage optical tap 11 taken off an incoming optical data signal 10 as their input source for monitoring. A tunable optical filter 12 with a predetermined tunable passband is varied in wavelength across a wavelength range of interest and light transmitted through the tunable filter 12 is provided to a photodetector 13. The optical power on the photodetector 13 is processed using digital signal processing circuitry 14, and the information is provided at an output port using an interface 15. The OPM provides simultaneous measurement of all WDM channels along a single optical fiber, an example spectrum is shown in FIG 2.

This type of OPM measures low frequency spectral domain properties, such as optical power levels, optical signal to noise ratio, and estimates of peak wavelengths. Unfortunately, no information pertaining to optical data quality on a per wavelength channel basis is provided. This type of device is therefore referred to as a spectrum domain OPM. It would be desirable to add optical data performance monitoring in the time domain and protocol domain (T/P) such that the OPM monitors optical data signal performance in addition to spectral information.

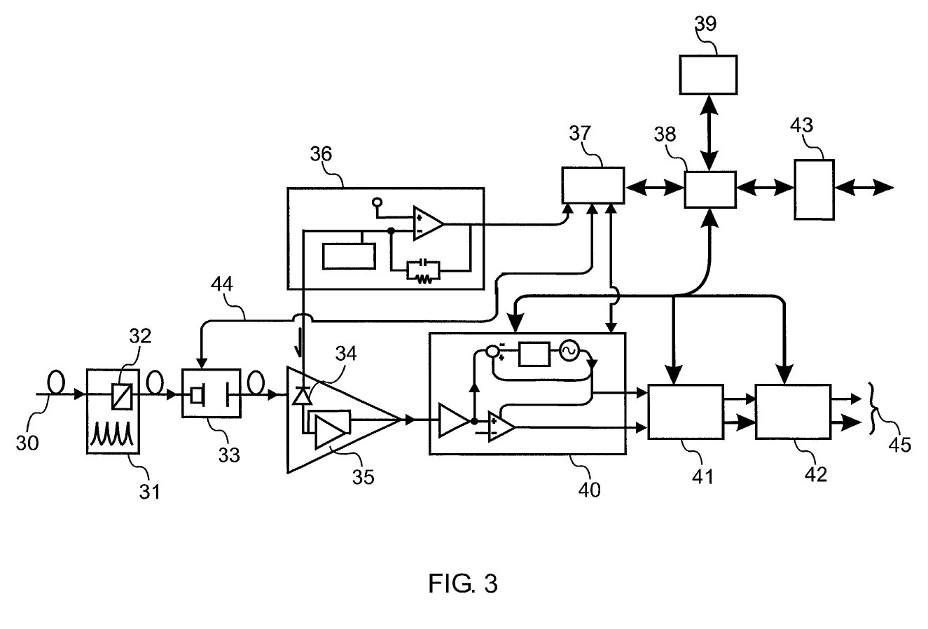

In FIG. 3, a block diagram of the primary embodiment is shown. The primary embodiment is of a spectrum, time and protocol (ST/P) optical performance monitor (STPOPM). An incoming WDM optical data signal enters the STPOPM through an input port 30, and transmits through to an optical coupler 32. A wavelength reference light source 31 having a known spectral characteristic is added to the incoming data signal using the coupler 32. The reference signal, as well as the optical data signal, comprises a combined optical signal. This combined optical signal is optically coupled to a tunable optical filter 33. The tunable filter and has a predetermined wavelength passband, such that a filtered portion of the incoming combined optical data signal is provided to an optically coupled high speed photodetector 34, such as a PIN diode.

The PIN bias and photocurrent measurement circuit 36 reads photocurrent from the photodetector 34, as well as provides a reverse bias voltage to the photodetector 34. The photodetector is electrically coupled between the PIN bias and photocurrent measurement circuit 36 and a low noise amplifier (LNA) circuit 35. The output of the LNA circuit 35 is coupled to a CDR (clock and data recovery) circuit 40. Outputs from the CDR circuit 40 couple to a demultiplexer circuit 41, with each of the output ports from the demultiplexer circuit 41 coupling to a protocol analyzer circuit 42. Protocol analyzer output ports are provided for sending data about the quality of the optical data signal. Electrical output signals from the PIN bias and photocurrent measurement circuit 36 are input into an analog to digital converter circuit 37 which then couples into a digital signal processor (DSP) circuit 38 for further processing and storage in external data memories 39 and 43. The DSP outputs a tuning voltage 44 to the tunable filter 33 for changing the spectral position of the filter passband.

The purpose of the wavelength reference is to generate known and stable wavelength peaks. For the primary embodiment, a LED light source is used. Light emitted from the LED light source is collimated and passed through a thin film etalon filter. The etalon filter is a Fabry-Perot (FP) type, such that when illuminated by the collimated LED light source, generates an output signal having a spectral response of known and stable wavelength peaks. Generally these peaks are located at frequencies, or wavelengths, that are integer related multiples of the etalon FP cavity length. Ideally the spectral location of these peaks is in the valley between adjacent optical data signal wavelength peaks, corresponding to predetermined optical network standards, such as the ITU. These wavelength peaks are used for calibrating the optical filter passband wavelength position vs tuning voltage.

In use, the tunable optical filter 33 is spectrally positioned in order to transmit a specific wavelength passband to the photodetector 34. One possible embodiment of the tunable filter is a piezoelectric tunable Fabry-Perot (FP) filter. The tuning voltage 44 changes a length of the FP cavity through piezoelectric material expansion or contraction. Varying the length of the FP cavity causes the filter passband to spectrally shift in a direction in dependence upon whether the FP optical cavity is expanded or contracted.

The PIN bias Photocurrent Measurement 36, or low speed converter, is a low frequency response electrical circuit. Ideally this circuit has a 50 dB dynamic range, such that the smallest optical power measurable is −50 dBm and the highest is 0 dBm. The two functions of this circuit are to convert photocurrent generated in the photodetector 34 to a voltage for later signal processing, and the other function is to provide a DC reverse bias for the photodetector 34. This is advantageous since less demand is placed on high speed PIN/LNA 35 electronics for providing the reverse bias voltage to the coupled photodetector.

The LNA 35 circuit performs optical to electrical (O/E) conversion of the filtered portion of the incoming combined optical data signal. A first photodetector 34 output port, anode, is coupled to a LNA. The LNA is different from the low speed photocurrent to voltage converter in that the upper frequency response is much higher. Low speed circuits typically have a frequency response in the order of ˜100 kHz, the LNA has a frequency response in the order of 2 to 3 GHz. Advantageously, since the LNA does not operate well at low frequencies, the PIN bias Photocurrent Measurement 36 circuit is used for low frequency measurements; the photodetector 34 is connected to both the LNA 35 and the low speed converter 36, through first and second output ports.

The main components of the clock and data recovery (CDR) circuit 40 are an automatic gain control circuit (AGC), a decision circuit, a phase locked loop (PLL) circuit, and eye measurement circuitry. The Automatic gain control circuit (AGC) is use to take the analog data stream provided from the LNA and to ensure there is enough signal amplitude to ensure sufficient voltage is provided to the decision circuit. The PLL circuit is used to recover clock information from the analog data stream to ensure a predetermined phase for the decision circuit. The decision circuit is used to sample the data waveform at the output of the AGC at a predetermined phase and voltage; output data of the decision circuit is either a “1” or “0” depending on whether the signal at sampling time was above or below a sampling threshold. Advantageously, this circuit includes eye parameter electronics, which allow for measurement of eye properties, such as phase margin and amplitude margin, of the data signal.

The demultiplexer 41 and protocol analyzer 42 are used for Protocol measurements. Retimed data is read from the CDR and demultiplexed into parallel data lines. The protocol ASIC circuit 42 accepts the parallel data lines, for performing protocol analysis. Protocol specific checks can be performed for standard communication protocols, such as T/P measurements such as SONET and GigE. The output signal from this circuit is provided via output ports 45 and contains information relating to protocol or timing violations that may have occurred in the received optical data signal.

In use, the tunable filter has two modes of operation, a sweep mode and a lock mode. In sweep mode the tuning voltage is ramped up and down causing the filter to sweep the entire optical spectrum. The mode is used to measure the optical spectrum of the combined optical signal. In lock mode the filter is locked at a specific fixed peak wavelength so that combined optical signal properties are measurable.

Hysteresis within the piezoelectric element causes the tunable filter 33 to have a different spectral passband position in dependence upon whether the tuning voltage 44 is increased or decreased from an original tuning voltage value. Hysteresis is independent of creep or drift. In the tunable filter however, both creep and drift are compensated for by using an optical feedback loop as well as through periodic calibration. Through continuous calibration of the tunable filter, the effects of drift and creep are almost eliminated. However for the feedback mechanism to function there must be enough optical power in the reference source to provide a feedback signal to keep the filter locked to a desired wavelength.

In a STPOPM calibration mode the tunable filter 33 is swept up and down over a predetermined wavelength range, and the measured photocurrent on the photodetector 34 contains not only the peaks of the data signal but also those of the wavelength reference 31. Two calibration sweeps are taken, one with the reference source enabled, and the other with the reference source disabled. This results in two data sets of values stored in memory 39. One set is for photocurrent and corresponding tuning voltages with the reference source enabled, and the other is for photocurrent and corresponding tuning voltages for when the reference source is disabled. Assuming that tunable filter optical parameters did not change between the two sweeps, the photocurrent measurements are subtracted from each other and the resulting signal is used as a wavelength reference. A DSP algorithm is applied to the data sets to determine the spectral location of peaks in relation to applied tuning voltages. Using a curve fitting algorithm a correlation is made between the actual wavelength reference peaks and applied tuning voltages, resulting in a passband wavelength position vs applied tuning voltage calibrated data set.

For ideal spectral operation of an OPM a very narrow passband tunable filter is ideal; this allows for higher resolution measurement of the spectral properties of an incoming signal. However for T/P analysis, the passband must be wide enough to allow all the high frequency data to pass. If the filter is too narrow, a portion of the optical signal is truncated by the filter, resulting in erroneous and poor T/P data quality.

Unfortunately, there arises a difficulty when trying to use the same optical filter to do T/P and spectrum performance monitoring. For spectrum monitoring, narrower filter bandwidth leads to higher wavelength resolution. For a T/P measurement however, the bandwidth of the filter cannot be narrower than approximately twice the data rate of the optical data signal. There is, therefore, a compromise in tunable optical filter passband width selection.

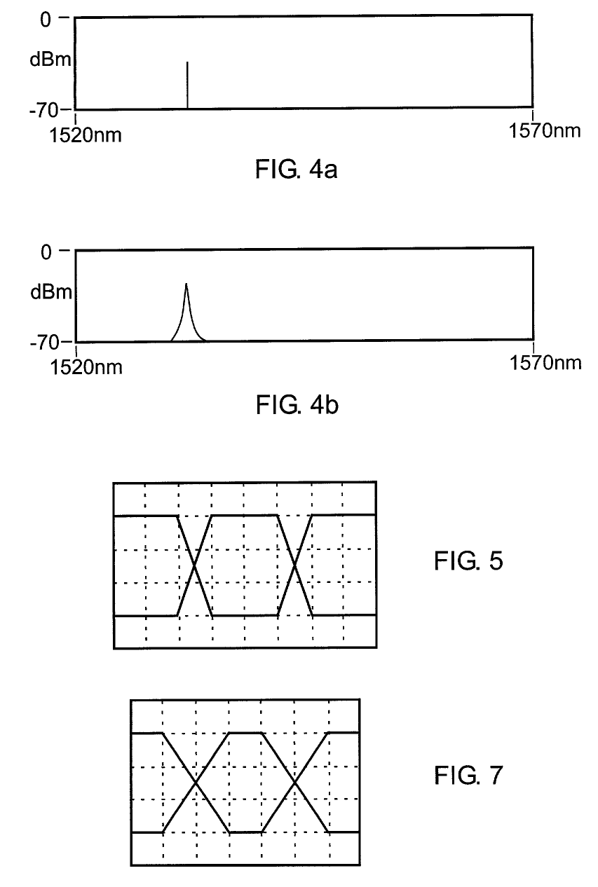

To illustrate this difficulty, FIG. 4 shows a single channel WDM optical data signal before and after modulation. In FIG. 4a, an unmodulated spectral scan of single channel optical data signal is shown. Once the signal is modulated at 10 Gb/s, as in FIG. 4b, the spectral width of the single channel is broadened about its central wavelength. FIG. 5, depicts an eye diagram for the modulated signal. The eye has clean sharp rising and falling edges, indicative of close to ideal optical parameters such as phase and amplitude margin.

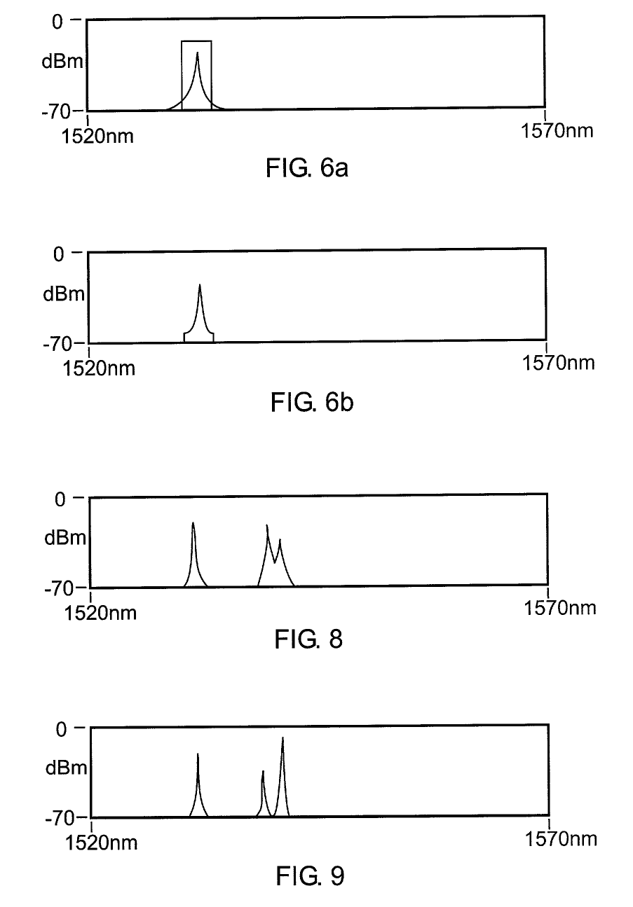

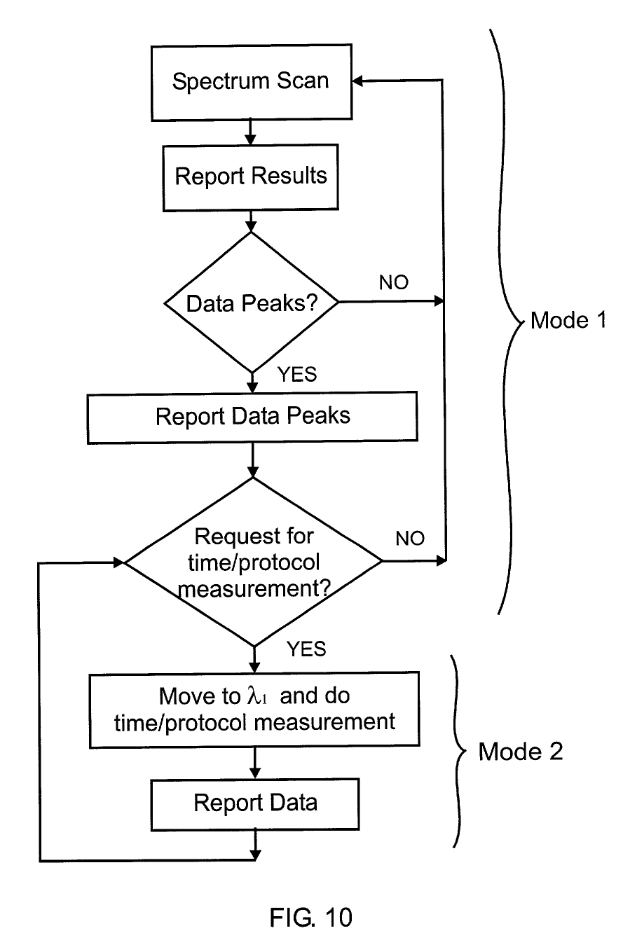

If a narrow tunable filter passband is used, high frequency data information is cut from the optical data signal, as is illustrated in FIG. 6. FIG. 6a shows the spectral shape of the optical passband of the tunable filter as well as the modulated single optical channel spectral shape. In FIG. 6b, after filtering, the quality of the transmitted portion of the single channel optical data signal is degraded since a portion of the light is removed by the filtering process. The effects of this are seen in the eye diagram of FIG. 7. In this case the eye is narrower due to a decrease in phase margin.

The original eye, shown in FIG. 5, has been degraded by the STPOPM tunable filter, and the resulting data does not accurately represent the incoming optical data signal to the OPM. Therefore, a filter with a passband larger than the WDM data signal spectral width, but narrow enough to block out neighboring optical wavelength channels, is required.

The DSP 38 circuit has an additional function, to perform inverse FFT on stored spectral data provided by the photocurrent measurement circuit; it is used to deconvolve the known spectral shape of the tunable filter passband from stored spectral data in order to more accurately represent the optical spectrum. FIG. 8 illustrates the spectral shape of the tunable filter having a 20 GHz passband; and. FIG. 9 illustrates the optical spectrum after filtering through the 20 GHz filter passband.

The STPOPM is externally controllable in terms of whether to provide spectral information or T/P information for an incoming optical data signal. A flow chart illustrating these two modes of operation is summarized in FIG. 11. Either of the two modes of operation are selected via control ports provided as part of the STPOPM. However, a spectral scan is required prior to a T/P measurement.

In a first mode, Mode 1, a spectral scan is externally initiated on the STPOPM. Once spectral peaks have been obtained for the combined optical signal the spectral data is internally stored for processing, as well as possibly outputted from the STPOPM. In a second mode, Mode 2, the filter 33 is tuned to a specific wavelength of interest and held in place using the feedback signal. Here the PIN/LNA 35, CDR 40, Demux 41 and Protocol Analyzer 42 process the single wavelength optical data signal and extract for T/P information about the data signal; accessible via output ports 45. The actively received optical data is analyzed for optimal eye quality parameter.

Advantageously, the choice of this particular filter pass band width and appropriate digital signal processing techniques results in a measurement device which simultaneously provides both T/P performance monitoring and spectrum information about an optical data signal input thereto. Inventively the STPOPM utilizes the distinguishing feature of a wide filter passband over the prior art, thereby enabling for T/P performance monitoring as well as more accurate spectral monitoring.

Numerous other embodiments may be envisaged without departing from the spirit or scope of the invention.

What is claimed is:

1. An optical performance monitor having an output port for monitoring a modulated optical data signal incident thereon comprising:
a photodetector having an optical input port, and a first output port and a second output port, the photodetector for providing a first non-optical data signal, based on light incident on the optical input port, at the first output port and for providing a second non-optical data signal based on light incident thereon at the second output port;
a tunable filter having a predetermined passband spectrum for receiving the modulated optical data signal and for providing a filtered portion of the modulated optical data signal to the photodetector;
a low frequency electronic circuit coupled to the first port of the photodetector for receiving the first non-optical data signal and for extracting first spectral information from the first non-optical data signal;
a high frequency electronic circuit coupled to the second port of the photodetector for receiving the second non-optical data signal and for extracting timing and protocol information from the second non-optical data signal; and,
a processor for receiving the first spectral information and for deconvolving the predetermined passband spectrum and the first spectral information, to provide data relating to the optical data signal at the optical performance monitor output port; and the processor for providing data relating to extracted timing and protocol information.

2. A spectrum, time and protocol domain optical performance monitor according to claim 1 wherein the passband width of the tunable filter is dependent on the modulation frequency of the optical data signal.

3. A spectrum, time and protocol domain optical performance monitor according to claim 2 wherein the passband width of the tunable filter is approximately twice the data rate of the optical data signal.

4. A spectrum, time and protocol domain optical performance monitor according to claim 3 wherein during use frequency of operation of the high frequency electronic circuit is at the data rate of the optical data signal.

5. A spectrum, time and protocol domain optical performance monitor according to claim 4 wherein the low frequency electronic circuit provides a biasing voltage to the photodetector.

6. A spectrum, time and protocol domain optical performance monitor according to claim 1 wherein the photodetector is coupled between the low frequency and high frequency circuit input ports.

7. A method of monitoring a modulated optical data signal comprising the steps of:
filtering an incoming modulated optical data signal using a tunable filter having a predetermined passband spectrum;
provide the filtered modulated optical data signal to a photodetector;
converting light incident on the photodetector to a first non-optical signal using a low frequency circuit;
extracting first spectral information from the first non-optical data signal; and,
deconvolving the predetermined passband spectrum and the first spectral information to provide data relating to the optical data signal.

8. A method according to claim 7 comprising the steps of:
converting light incident on the photodetector to a second non-optical signal using a higher frequency circuit;
extracting timing and protocol information from the second non-optical data signal.

9. A method of monitoring a modulated optical data signal according to claim 7 wherein the step of deconvolving the predetermined passband spectrum and the first spectral information reduces the filter related effects within the spectral response of the data signal.

10. A method of monitoring a modulated optical data signal according to claim 8 wherein the predetermined width of the passband of the tunable filter is selected based on the modulation rate of the optical data signal.

11. A method of monitoring a modulated optical data signal according to claim 10 wherein the predetermined width of the passband of the tuneable filter is additionally dependent upon the spectral channel spacing of the optical data signal.

12. A method of monitoring a modulated optical data signal according to claim 7 wherein the effects due to the predetermined spectral width of filtering of the optical data signal are reduced by the step of deconvolution.

13. A method of monitoring a modulated optical data signal according to claim 7 wherein the low frequency circuit provides a bias voltage to the photodetector.

14. A method of monitoring a modulated optical data signal according to claim 8 wherein spectral position of the tunable filter is approximately fixed in wavelength prior to converting light incident on the photodetector to a second non-optical signal.

15. A method of monitoring a modulated optical data signal according to claim 14 wherein the approximately fixed tunable filter is for passing a single wavelength optical data signal.

16. A method of monitoring a modulated optical data signal according to claim 8, wherein the passband width of the tuneable filter is approximately twice the data rate of the optical data signal.

17. A method of locking a filter position based on a peak location within a spectrum of an optical signal comprising the steps of:
providing an optical signal including a first optical signal and a reference optical signal having a known spectrum;
filtering the provided optical signal using a first filter;
detecting at least a portion of the filtered optical signal using a detector; and,
tuning the first filter in dependence upon a detected portion of the at least a portion of the filtered optical signal relating to a portion of the provided optical signal including the reference optical signal.

18. A method of locking a filter position according to claim 17 wherein the first filter is tuned based on a feedback signal, the feedback signal provided from the detector.

19. A method of locking a filter position according to claim 18 wherein the feedback signal is provided at intervals and wherein the reference signal is one of attenuated and provided with reduced intensity during times between said intervals.
